(19) United States
(12) Patent Application Publication
(10) Pub. No.: US 2010/0058724 A1
(43) Pub. Date: Mar. 11, 2010

(54) AIR CLEANING APPARATUS FOR CEILING

(76) Inventor: Dong-ku Kim, Gunpo-si (KR)

Correspondence Address: CHRISTOPHER PAUL MITCHELL, 888 16TH ST., NW, SUITE 800, WASHINGTON, DC, 20006, US

(21) Appl. No.: 12/593,286

(22) PCT Filed: May 21, 2008
(86) PCT No.: PCT/KR08/02819

§ 371 Date: Sep. 25, 2009

(30) Foreign Application Priority Data
May 21, 2007 (KR) 10-2007-0049391

(51) Int. Cl. B01D 46/24

(52) U.S. Cl. 55/510; 55/495

(57) ABSTRACT

The present invention relates, in general, to air cleaning apparatuses and, more particularly, to a ceiling-mounted air cleaning apparatus which can be conveniently installed and used as room ventilation equipment, which discharges contaminated indoor air to the outside a room and supplies fresh outdoor air to the interior of a room so as to maintain clean air in the interior of the room. The ceiling-mounted air cleaning apparatus of the present invention includes an upper casing (10), which is removably mounted to a ceiling, a lower casing (20), which is separably coupled to the upper casing, a filter unit (30), which is provided between the upper and lower casings, and a locking unit (40), which separably couples the upper and lower casings to each other.

### TECHNICAL FIELD

The present invention relates, in general, to air cleaning apparatuses and, more particularly, to a ceiling-mounted air cleaning apparatus which can be conveniently installed as room ventilation equipment, which discharges contaminated indoor air to the outside of a room and supplies fresh outdoor air to the inside of the room so as to maintain the air of the room in a clean state.

### BACKGROUND ART

Generally, air cleaning apparatuses are installed as room ventilation equipment to eliminate or reduce contaminants in rooms. In such an air cleaning apparatus, air is purified by passing air through a filtering device, which filters dust from the air.

In a conventional air purification method, a single air cleaning apparatus (including a single filter medium) is installed at a predetermined position in a building, and air is supplied into the entire building through the air cleaning apparatus and ducts. However, to supply air to all floors and all rooms, the ducts must be relatively large and long, thus increasing the cost required to arrange the ducts. Furthermore, because the ducts are relatively long, the capacity of a fan motor for supplying air must also be large, thus increasing power consumption. In addition, in this conventional ceiling-mounted air cleaning apparatus, installation thereof in a ceiling in the building or removal thereof inconveniences workers. Thus, there is a disadvantage in that it is difficult to replace the filter medium or other components with new ones or repair them.

Moreover, a filter unit, which is provided in the conventional ceiling-mounted air cleaning apparatus, has a shape similar to that of a picture frame. For example, in the case where a sheet of flat glass and a picture are fitted into an insert seat of the picture frame after adhesive is applied to the insert seat of the picture frame, the picture and the flat glass cannot be separated from the picture frame. In a similar manner, in the conventional air cleaning apparatus, the filter medium cannot be separated from the filter unit, so that it is impossible to replace only the filter medium with a new one. In other words, because the filter medium is fixed to the body of the filter unit using adhesive, when it is desired to replace the filter medium with a new one, the entire filter unit must be replaced with a new one. Hence, there is a problem in that the amount of waste has been increased. Furthermore, because the filter medium has a shape similar to that of a sheet of flat glass, the area of the outer surface of the filter medium is relatively small. Therefore, there are disadvantages in that air resistance is increased and the filter medium becomes easily clogged. Particularly, in the summer, noxious insects or dayflies are easily trapped by the filter medium, with the result that the filter medium clogs.

Accordingly, the present invention has been made keeping in mind the above problems occurring in the prior art, and an object of the present invention is to provide a ceiling-mounted air cleaning apparatus which facilitates the installation or removal thereof, thus making it easy to replace a filter medium or other components with new ones or to repair them.

Particularly, the present invention is assembled by tightening coupling members, such as nuts and bolts, without using a separate adhesive, thus facilitating replacement of the filter medium. Furthermore, casings, which hold the filter medium, can be continuously used. Therefore, maintenance costs of the air cleaning apparatus and the amount of waste generated can both be reduced.

Moreover, in the case of the air cleaning apparatus of the present invention, a hole having a diameter of about 150 mm is foamed through the wall of the room at a position adjacent to a window or a window frame that supports the window. A corrugated pipe having a diameter of about 150 mm is used, and a fan motor having an output of about 15 W is connected to the corrugated pipe. Thereafter, the air cleaning apparatus may be installed on the wall or the ceiling. As such, in the case where the air cleaning apparatus is installed on the ceiling or wall such that the pipe is arranged to a relatively short length of 3 mm or less, the installation costs thereof are reduced, and the installation work is simplified. Therefore, the present invention is advantageous in that the installation and maintenance costs thereof are reduced by relatively low power consumption and the use of the inexpensive filter.

Another object of the present invention is to provide a ceiling-mounted air cleaning apparatus which has a superior external appearance.

### DISCLOSURE OF INVENTION

In order to accomplish the above objects, the present invention provides a ceiling-mounted air cleaning apparatus, including: an upper casing mounted to a ceiling so as to be removable; a lower casing coupled to the upper casing so as to be separable; a filter unit provided between the upper and lower casings; and a locking unit to separably couple the upper and lower casings to each other.

The locking unit may be provided on outer rims of the upper casing and the lower casing which face each other, so that the upper casing and the lower casing are locked to each other by the locking unit such that the outer rims of the upper casing and the lower casing which face each other are spaced apart from each other by a predetermined distance.

The locking unit may include one or more support plates fastened to the outer rim of the upper casing; a rotating member provided on each of the support plates so as to be pivotable; a locking catch provided on each of the rotating members so as to be pivotable; one or more locking hooks provided on the outer rim of the lower casing, the locking hooks being removably locked to the corresponding locking catches; and a reinforcing plate provided behind each of the locking hooks, the reinforcing plate supporting the corresponding support plate.

The filter unit may include an annular filter medium having a passing space which interfaces with a tubular coupling part of the upper casing; an annular upper holder coupled to a first end of the filter medium, the annular upper holder having an opening which interfaces with the tubular coupling part of the upper casing; and a lower holder coupled to a second end of the filter medium, the lower holder being separably coupled to the upper holder using a coupling member.

The upper casing may be removably mounted to the ceiling using a mounting bracket, and coupling holes may be formed through portions of the mounting bracket and the upper casing which face each other, wherein each of the coupling holes of the mounting bracket may be smaller than the corresponding coupling hole of the upper casing.

Hereinafter, preferred embodiments of the present invention will be described in detail with reference to the attached drawings.

FIGS. 1 through 4 illustrate a ceiling-mounted air cleaning apparatus according to a first embodiment of the present invention.

As shown in the drawings, the ceiling-mounted air cleaning apparatus of the present invention includes an upper casing 10, which is removably mounted to a ceiling, a lower casing 20, which is removably coupled to the upper casing 10, a filter unit 30, which is provided between the upper and lower casings 10 and 20, and a locking unit 40, which separably couples the upper and lower casings 10 and 20 to each other in such a way that the upper and lower casings 10 and 20 are spaced apart from each other.

Typically, the structure of the ceiling includes a ceiling slab 1 and a ceiling panel 2, which are spaced apart from each other by a predetermined distance d. In detail, the ceiling panel 2 is supported, at a position spaced apart from the ceiling slab 1 by the distance d, by a hanger (not shown) and a horizontal support 2a, which are provided on the ceiling slab 1.

The upper casing 10 has a tubular coupling part 12 on the central portion of the upper surface thereof. A suction pipe 3, which interfaces with outdoor air, is fitted over the tubular coupling part 12. A suction fan (not shown) is provided in the suction pipe 3, so that outdoor air is drawn into the room by the operation of the suction fan through the suction pipe 3.

Furthermore, a plurality of coupling holes 11, into which respective coupling members 19 are tightened, is formed through the upper surface of the upper casing 10, so that the upper casing 10 can be mounted to the ceiling using a mounting bracket 15.

The mounting bracket 15 may be coupled to the horizontal support 2a of the ceiling panel 2 using coupling members 17. The mounting bracket 15 has on the outer edge thereof a reinforcing rim 15b for increasing the strength thereof. Furthermore, an opening 16, through which the tubular coupling part 12 of the upper casing 10 is placed, is formed through the central portion of the mounting bracket 15. Coupling holes 15a are formed through the mounting bracket 15 at positions corresponding to the respective coupling holes 11 of the upper casing 10. Each coupling hole 15a of the mounting bracket 15 is smaller than the corresponding coupling hole 11 of the upper casing 10, so that the upper casing 10 can be more firmly fastened to the mounting bracket 15 using the coupling members 18.

The mounting bracket 15 serves to mount the upper casing 10 to the ceiling more firmly. Particularly, in the case of, for example, an apartment building, although ceiling space is relatively small (that is, although the distance d of FIG. 3 between the ceiling slab 1 and the ceiling panel 2 is short), because the upper casing 10 is mounted to the ceiling using the mounting bracket 15, the installation thereof is simplified, and the upper casing 10 can be more firmly fastened to the ceiling.

The lower casing 20 is coupled to the upper casing 10 using the locking unit 40 in such a way that the upper casing 10 and the lower casing 20 are spaced apart from each other by a predetermined distance.

The filter unit 30 serves to filter out dust from outdoor air, which is drawn into the air cleaning apparatus through the tubular coupling part 12 of the upper casing 10, and discharge filtered air into the room. Furthermore, the filter unit 30 can also conduct a sound absorbing function for the prevention of noise.

The filter unit 30 includes an annular filter medium 31, which has a passing space 31a which interfaces with the tubular coupling part 12 of the upper casing 10, an annular upper holder 32, which is fitted over a first end of the filter medium 31, and a lower holder 33, which is fitted over a second end of the filter medium 31.

A filter medium, which is made of fiber, such as filter cloth, paper, pelt, sponge, etc., is used as the annular filter medium 31. Preferably, the filter medium 31 is corrugated to enhance the filtering and the sound absorbing performance.

The upper holder 32 has a doughnut shape, which has in the central portion thereof an opening 32a that interfaces with the tubular coupling part 12 of the upper casing 10. The upper holder 32 has in the perimeter thereof a coupling depression 32b, which is fitted over the first end of the filter medium 31.

The lower holder 33 has a disk shape, which has a closed part 33a on the central portion thereof. The lower holder 33 has in the perimeter thereof a coupling depression 33b, which is fitted over the second end of the filter medium 31.

Furthermore, a plurality of coupling holes 32c is formed through the upper holder 32 in an area surrounding the opening 32a. Coupling holes 33c are formed through the lower holder 33 at positions corresponding to the respective coupling holes 32c of the upper holder 33. Coupling members 35 are removably tightened into the corresponding coupling holes 32c and 33c, thus facilitating work of replacing the filter medium 31 with a new one or the repair thereof.

The filter unit 30 further includes a filter net 34, which is provided around the circumferential outer surface of the filter medium 31. The circumferential outer surface of the filter medium 31 is covered with the filter net 34, thus improving its appearance.

The locking unit 40 is provided on the outer rims of the upper casing 10 and the lower casing 20 which face each other. The upper casing 10 and the lower casing 20 are locked to each other by the locking unit 40 in a way such that the outer rims of the upper casing 10 and the lower casing 20 are spaced apart from each other, so that the circumferential outer surface of the filter medium 31 is exposed to the room.

The locking unit 40 includes one or more support plates 41, which are fastened to the outer rim of the upper casing 10, a rotating member 42, which is pivotably provided on each support plate 41, a locking catch 43, which is pivotably provided on each rotating member 42, one or more locking hooks 44, which are provided on the outer rim of the lower casing 20, and a reinforcing plate 45, which is provided on the rear surface of each locking hook 44.

The support plates 41 arranged along the outer rim of the upper casing 10 in the circumferential direction. The support plates 41 extend predetermined lengths towards the lower casing 20.

Each rotating member 42 is provided on the corresponding support plate 41 so as to be pivotable using a hinge pin 42a. The locking catches 43 are pivotably provided on the respective rotating member 42. The distal ends of the locking catches 43 are locked to the respective locking hooks 44. Thereby, the upper and lower casings 10 and 20 are coupled to each other.

The locking hooks 44 are arranged on the outer rim of the lower casing 20 in the circumferential direction at positions corresponding to the respective support plates 41. The reinforcing plates 45 are fastened to the lower casing behind the respective locking hooks 44. The reinforcing plates 45 also serve to support the rear surfaces of the respective support plates 41.

In the locking unit 40, as shown in FIG. 4, after the filter unit 30 is interposed between the upper and lower casings 10 and 20, the distal ends of the locking catches 43 are hooked to the corresponding locking hooks 44. Thereafter, the rotating members 42 are rotated towards the upper casing 10. Thereby, the upper and lower casings 10 and 20 are firmly coupled to each other. Here, because the reinforcing plates 45 support the rear surfaces of the respective support plates 41, the coupling of the locking catches 43 to the respective locking hooks 44 can be maintained more firmly. Therefore, the coupling between the upper and lower casings 10 and 20 can also be maintained more reliably.

Meanwhile, referring to FIG. 4, when the rotating members 42 are rotated towards the lower casing 20, the locking catches 43 are removed from the respective locking hooks 44, the coupling therebetween is unfastened. At this time, the lower casing 20 and the filter unit 30 can be separated from the upper casing 10.

FIG. 5 illustrates a ceiling-mounted air cleaning apparatus according to a second embodiment of the present invention. The ceiling-mounted air cleaning apparatus according to the second embodiment is characterized in that it is partially embedded in the ceiling panel 2 such that the exposure thereof is reduced, thus ensuring more a superior external appearance.

In the second embodiment of the present invention, a seating depression 15a, in which part of an upper casing 10 is seated, is formed in a central portion of a mounting bracket 15. Hence, the upper casing 10 is partially inserted into the seating depression 15a of the mounting bracket 15, so that the air cleaning apparatus of the second embodiment is partially embedded in the ceiling panel 2.

The second embodiment having the above-mentioned structure is suitable for a building, such as an office building, in which a distance d between the ceiling slab 1 and the ceiling panel 2 is relatively large.

FIG. 6 illustrates a ceiling-mounted air cleaning apparatus according to a third embodiment of the present invention. The air cleaning apparatus according to the third embodiment is characterized in that an upper casing 10 is directly mounted to the horizontal support of the ceiling panel 2 without using a mounting bracket 15.

In the third embodiment, the upper casing 10 has a relatively long sidewall 13, part of which is placed inside the ceiling panel 2. A reinforcing rim 10b is provided on the lower edge of the sidewall of the upper casing 10. The upper casing 10 is directly coupled to the horizontal support 2a of the ceiling panel 2 using coupling members 17, so that part of the upper casing 10 is embedded in the ceiling panel 2. A lower casing 20 and a filter unit 30 are coupled to the upper casing 10 using a locking unit 40.

As such, because the sidewall 13 of the upper casing 10 is relatively long, the filter unit 30 having a relatively long length can be provided in the upper casing 10, thus enhancing the filtration performance and the sound absorbing performance of the air cleaning apparatus.

In the same manner as the second embodiment, the air cleaning apparatus according to the third embodiment is very suitable for a building, such as an office building, in which a distance d between the ceiling slab 1 and the ceiling panel 2 is relatively large.

### BRIEF DESCRIPTION OF THE DRAWINGS

FIG. 1 is a perspective view showing a ceiling-mounted air cleaning apparatus, according to a first embodiment of the present invention;

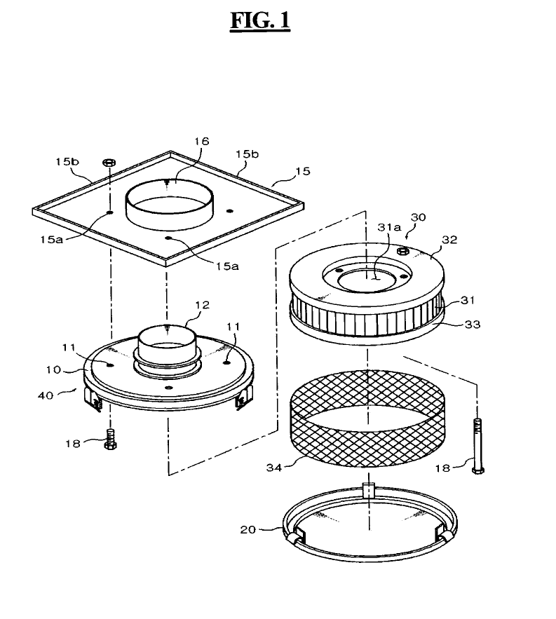

FIG. 2 is an exploded perspective view showing the ceiling-mounted air cleaning apparatus according to the first embodiment of the present invention;

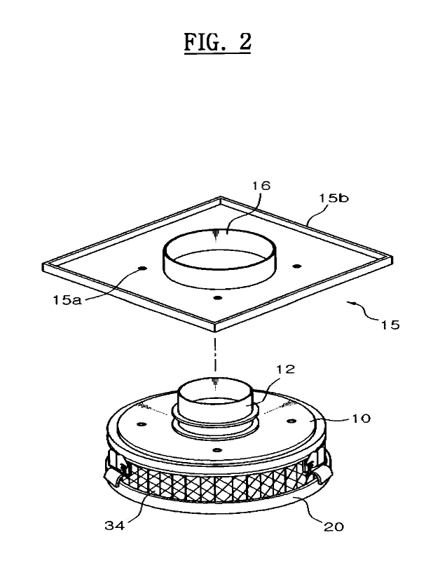

FIG. 3 is a sectional view of the ceiling-mounted air cleaning apparatus according to the first embodiment of the present invention;

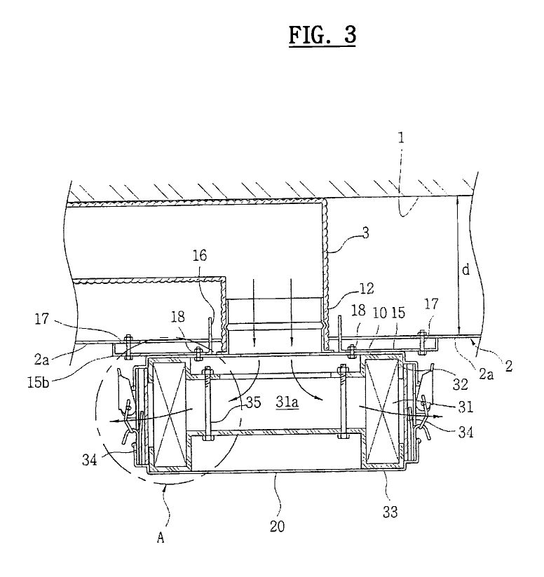

FIG. 4 is an enlarged view of the circled portion A of FIG. 3;

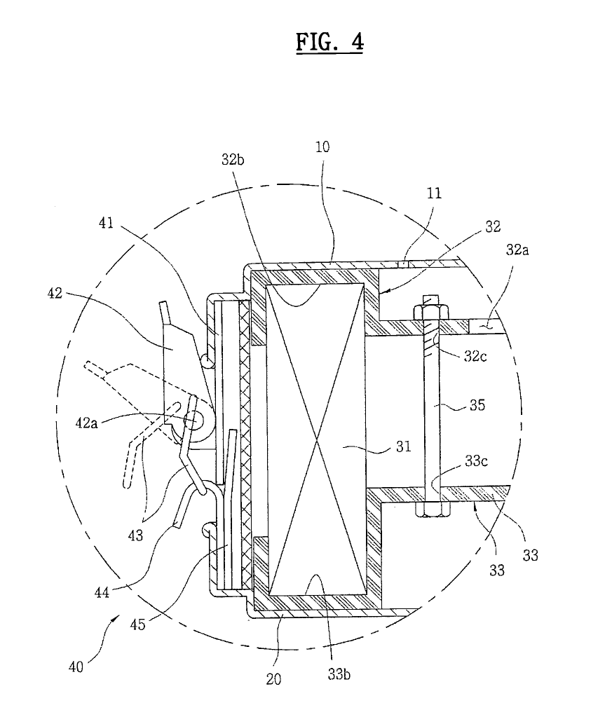

FIG. 5 is a sectional view of a ceiling-mounted air cleaning apparatus, according to a second embodiment of the present invention; and

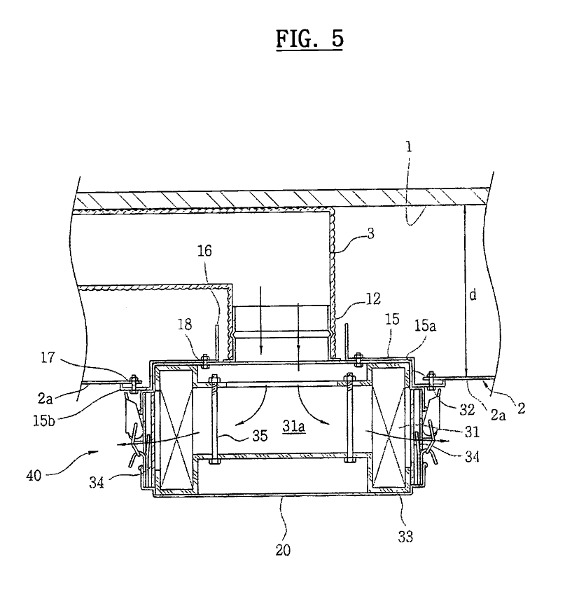

FIG. 6 is a sectional view of a ceiling-mounted air cleaning apparatus, according to a third embodiment of the present invention.

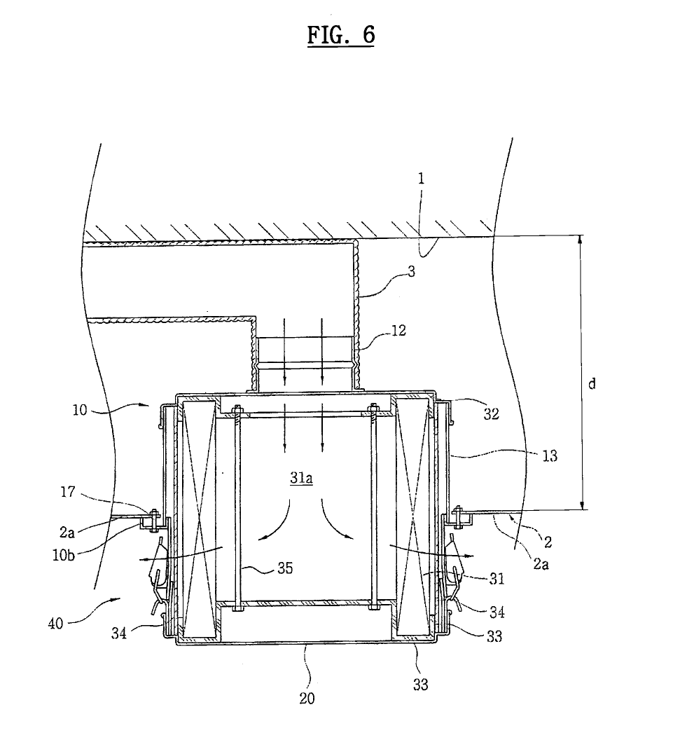

### DESCRIPTION OF THE ELEMENTS IN THE DRAWINGS

10: upper casing 20: lower casing
30: filter unit 40: locking unit

### INDUSTRIAL APPLICABILITY

As described above, in the present invention, because a filter medium is assembled with upper and lower casings using coupling members, such as nuts and bolts, without using an adhesive, the filter medium can be easily separated from the upper and lower casings, thus facilitating the work of replacing the filter medium with a new one and the repair thereof. Furthermore, when the filter medium is replaced with a new one, only the used filter medium is discarded, but upper and lower holders for holding the filter medium can be continuously used. Therefore, maintenance costs of the air cleaning apparatus and the amount of waste can both be reduced.

In the case of a single room, a hole having a diameter of about 150 mm is formed through the wall of the room at a position adjacent to a window or a window frame that supports the window. A corrugated pipe having a diameter of about 150 mm is used, and a fan motor having an output of about 15 W is connected to the corrugated pipe. Thereafter, the air cleaning apparatus may be installed on the wall or the ceiling. As such, in the case where the air cleaning apparatus is installed on the ceiling or wall such that the pipe is arranged to a relatively short length of 3 mm or less, the installation costs thereof are reduced, and the installation work is simplified. Furthermore, the present invention is advantageous in that the installation and maintenance costs thereof are reduced owing to the relatively low power consumption and the use of the inexpensive filter. For example, in the case of an office of 165 square meters, several air cleaning apparatuses can be inexpensively and conveniently installed in respective rooms using a fan motor of about 150 W, a pipe, having a diameter of about 205 mm, and a distributor, which is connected to the pipe. In addition, when fresh outdoor air is forcibly supplied into a building via the air cleaning apparatus by the force of the fan motor, positive (+) pressure is created in the building, carcinogenic substances, which have covered the floor of the room, can be discharged outside the room by pneumatic pressure. In particular, in the case of a gap existing under a door of the room, the harmful substances can be pushed outside the room therethrough. In the case of a closed space, as for example, an underground shelter or a warehouse having a fire door but having no window, although positive pressure is created in the room by the supply of air, the fire door is not opened. Therefore, a rectangular pipe, which is arranged in the ceiling and extends to the floor of the room, may be installed in the room. Then, harmful substances, which have covered the floor of the room, can be discharged outside the room through the rectangular pipe. In this case, despite ventilation only 0.7 times per hour, which is a legal standard value, a satisfactory degree of removal of harmful substances can be achieved. Typically, because the specific gravities of harmful substances, such as carcinogenic substances, benzene, toluene, xylene (B.T.X), etc., are greater than that of oxygen, the harmful substances are placed on the floor of the room. In such a case, if a person, who sleeps for about seven hours everyday, uses the room for a long period, the person inhales a large amount of harmful substances, with the result that the possibility of being attacked by an incurable disease, such as various cancers or diabetes, is markedly increased. This is called sick house syndrome. The world health organization (WHO) categorically classified benzene as a carcinogenic substance. Because the specific gravities of carcinogenic substances, such as benzene, are greater than that of air, they are present at a height less than about 1 m from the floor of the room. In the conventional arts, a fan motor is installed in the ceiling such that raising oxygen and warm air are first discharged outside the room. In this case, harmful substances, such as benzene, are drawn into the room through the gap, which is defined under the door, thus further polluting the room. Particularly, in the case of an underground room, harmful substances, which have been drawn into the room, are seldom discharged outside the room. Therefore, people, who reside in the underground rooms, are easily exposed to a variety of diseases, such as respiratory diseases, various cancers, diabetes, etc. If the air cleaning apparatus of the present invention is installed in the underground room, funguses are removed, so that fungus smell is eliminated, thus clearing the head of the user. Meanwhile, in the case where the air cleaning apparatus of the present invention is installed in a newly constructed apartment house, harmful substances are first discharged notably to the outside. In particular, in hospitals, super viruses, which can be instigators of infection, are not eliminated by normal antibiotics. The Korean society for nosocomial infection control published that 15,000 people are infected in hospitals and die every year (Feb. 3, 2007, in Chosun daily newpaper). As such, due to poor room ventilation, a person, who visits a hospital to cure a disease, may become infected by another disease while in the hospital and die or became paralyzed on one side. However, if purified outdoor air is forcibly supplied into the hospital using the force of a fan motor, people in the hospital can inhale fresh air, which is supplied at a predetermined pressure, and moisture can be removed from the floor of the hospital building, so that even if a cloth for cleaning the floor is washed and spread out, it can be completely dried. In addition, bedclothes, sleeping mattresses and pillows are completely dried, so that ticks can also be dried up. The humidity in the room is similar to that of outdoor air, but even super viruses can be dried up and killed by using air pressure. Because 80% of the weight of funguses or ticks is water, they can be completely dried up and killed by supplying air at a predetermined pressure using the air cleaning apparatus of the present invention. Recently, sick office syndrome, in which a respiratory disease is induced by poor ventilation, has increased. Meanwhile, typically, in the case of an office, if air, which is heated by sunlight, is removed by room ventilation, the power rate of an air conditioner can be 80% cost reduced. That is, the power consumption of the air conditioner can be saved in the amount of 80 cents per normally spent dollar every month. As well, because workers in the office can have clear heads, work efficiency can be enhanced. If the air conditioner is used only in the afternoon of the hottest period of summer, sick office syndrome is prevented, and the health of the workers can be improved.

As described above, the ceiling-mounted air cleaning apparatus of the present invention facilitates the installation or removal thereof, thus making it easy to replace the filter medium or other components with new ones or repair them. Furthermore, the present invention is advantageous in that superior external appearance thereof is ensured.

1. A ceiling-mounted air cleaning apparatus, comprising:
an upper casing mounted to a ceiling so as to be removable;
a lower casing coupled to the upper casing so as to be separable;
a filter unit provided between the upper and lower casings; and
a locking unit to separably couple the upper and lower casings to each other.

2. The ceiling-mounted air cleaning apparatus according to claim 1, wherein the locking unit is provided on outer rims of the upper casing and the lower casing which face each other, so that the upper casing and the lower casing are locked to each other by the locking unit such that the outer rims of the upper casing and the lower casing which face each other are spaced apart from each other by a predetermined distance.

3. The ceiling-mounted air cleaning apparatus according to claim 2, wherein the locking unit comprises:
one or more support plates fastened to the outer rim of the upper casing;
a rotating member provided on each of the support plates so as to be pivotable;
a locking catch provided on each of the rotating members so as to be pivotable;
one or more locking hooks provided on the outer rim of the lower casing, the locking hooks being removably locked to the corresponding locking catches; and
a reinforcing plate provided behind each of the locking hooks, the reinforcing plate supporting the corresponding support plate.

4. The ceiling-mounted air cleaning apparatus according to claim 1, wherein the filter unit comprises:
an annular filter medium having a passing space which interfaces with a tubular coupling part of the upper casing;
an annular upper holder coupled to a first end of the filter medium, the annular upper holder having an opening which interfaces with the tubular coupling part of the upper casing; and
a lower holder coupled to a second end of the filter medium, the lower holder being separably coupled to the upper holder using a coupling member.

5. The ceiling-mounted air cleaning apparatus according to claim 1, wherein the upper casing is removably mounted to the ceiling using a mounting bracket, and coupling holes are formed through portions of the mounting bracket and the upper casing which face each other, wherein each of the coupling holes of the mounting bracket is smaller than the corresponding coupling hole of the upper casing.
